(19) United States
(12) Patent Application Publication
(10) Pub. No.: US 2007/0035140 A1
(43) Pub. Date: Feb. 15, 2007

(54) Enhanced spade and method of use

(76) Inventor: Richard Baldwin, Plainville, KS (US)

Correspondence Address: Galasso & Associates, LP, P.O. Box 26503, Austin, TX, 78755-0503, US

(21) Appl. No.: 11/199,714

(22) Filed: Aug. 9, 2005

(51) Int. Cl. A01B 1/00

(52) U.S. Cl. 294/60

(57) ABSTRACT

A hand and foot shovel which comprises an elongated handle, a metal spade, a hand end cap, a first foot pad and a second foot pad. The elongated handle is designed to relieve unnecessary pressure on the back during the digging and lifting process. The first and second foot pads are operable to assist in the digging process by allowing for additional leverage without bending or be required to get into the hole depending upon the depth that is being dug.

### FIELD OF THE DISCLOSURE

The enhanced spade provides back relief for its user by including a longer handle and additional an additional foot pad for digging.

### BACKGROUND

The shovel and spade have been around for years. Most every homeowner has at least one of these tools. They are also an integral part of most construction sites. The fact is that most everyone at some point in their life will use or have a need for a shovel or spade.

The current models while functional are not necessarily that easy to use. For example, the typical shovel has a long handle and a foot pad located on the base of the shovel. You can use the foot pad to help push the shovel into the ground. One problem with the typical shovel is that if you are short and are trying to use it, it is cumbersome with its long handle. Alternatively, if you are tall, the handle can be way too short. Typically, a spade has a shorter handle than a shovel yet it still contains a foot pad for helping to push the blade end. The shorter handle provides for better leverage but places tremendous pressure on the back of the user.

There are a couple of alternatives to the standard shovel and spade that exist. These include the flat foot plate that is disclosed in U.S. Pat. No. 4,461,458. The shovel or spade disclosed in this patent comprises a flat foot plate having a forward end and cleat which penetrates the ground to resist rearward displacement. While the flat foot plate will assist in digging, to get the best leverage it would be best used on a flat surface. Depending on the size of the hole that is being dug this foot plate could become more of a burden than an asset although it does provides an alternative to the digging process. U.S. Pat. No. 4,537,433 discloses an alternative to lifting the shovel or spade. It discloses a lever pivotally mounted beneath the axis of the shovel handle from a block attached to the handle. The lever member includes a pair of elongated handles disposed on opposite sides of the shovel handle and include an upper and lower grip to facilitate the lifting of heavy materials. This provides an additional means for lifting the shovel which provides more leverage. Finally, U.S. Pat. No. 6,684,459 discloses an alternative handle that is capable of being used on various tools. It comprises a bow shaped handle end section, a straight middle section and a fixing end section for attaching the tool. The various slants in the bow shaped handle provides different points on which the user can place pressure for purposes of gaining leverage. Additionally, it provides the user an alternative to the way a particular tool is used. For example, by using the bow shaped handle with a shovel it provides for easier shoveling from side to side or from front to back. In order to use the bow shaped area of the handle, effectively one would need to bend. This bending process places pressure on the back and leaves the user with sore muscles.

The current invention offers an alternative to the current digging devices on the market by providing a tool that also eases the pressure on the user's back.

### SUMMARY OF THE DISCLOSURE

In one embodiment, the hand and foot shovel comprises an elongated handle.

In still another embodiment the hand and foot shovel comprises a metal spade which includes a foot pad.

In yet another embodiment the hand and foot shovel comprises a hand end cap.

In another embodiment the hand and foot shovel comprises a second foot pad.

In yet another embodiment the hand and foot shovel would be constructed of galvanized metal.

In still another embodiment the hand and foot shovel handle would measure approximately one and eleven sixty-fourths in outside diameter and approximately forty-four inches in length.

In another embodiment the hand and foot shovel spade would measure approximately thirteen inches in length.

In yet another embodiment the hand and foot shovel would comprise a second foot pad measuring approximately six inches in width and approximately one and one-half inches in thickness.

In another embodiment the second foot pad would be welded to the handle of the hand and foot shovel.

In yet another embodiment, the hand and foot shovel would be comprise a slight curvature above the weld on the shovel blade.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a front view of the enhanced spade.

FIG. 2 is a back view of the enhanced spade.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

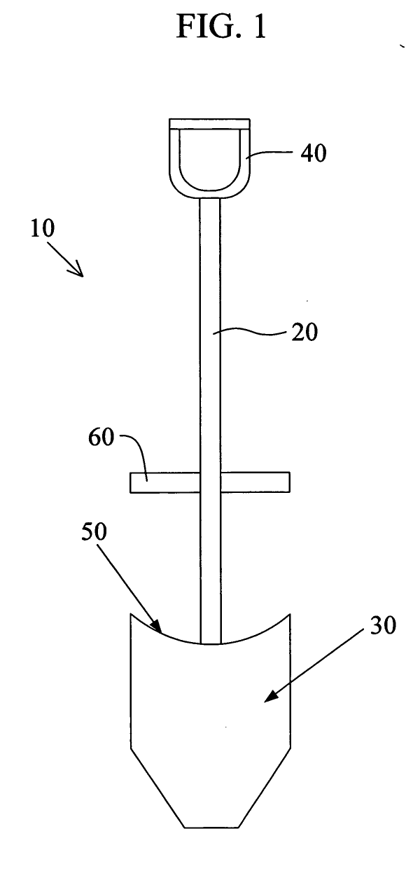

FIG. 1 depicts a hand and foot shovel 10, a handle 20, a metal spade 30, a hand end cap 40, a first foot pad 50 and a second foot pad 60. The handle 20 is attached to the metal spade 30 on one end and the hand end cap 40 on the opposite end. The handle 20 can be comprised of wood or galvanized steel. The handle 20 has an outside diameter of between one and two inches and is approximately forty to forty-five inches in length. The handle 20 operates in conjunction with the hand end cap 40 to cause the metal spade 30 to be driven into a digging area. The digging area could consist of dirt, rocks, mud or the like. Additionally, by having a longer handle than the currently available spade, the user eliminates unnecessary pressure on their back during both the digging and lifting process. Thus decreasing the risk of the user having sore muscles or even a pulled muscle. Additionally, FIG. 1 depicts a first foot pad 50 and a second foot pad 60. The first foot pad 50 and the second foot pad 60 are used to help push the metal spade 30 into the desired digging substance. The metal spade 30 is designed with sharp end for cutting through the desired digging substance and measures approximately thirteen inches in height from the digging edge up to the and including the first foot pad 50.

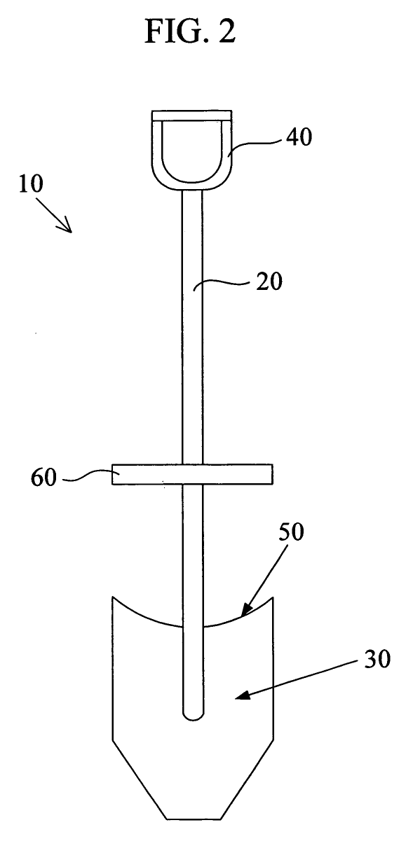

FIG. 2 depicts a back view of a hand and foot shovel 10. It also depicts a handle 20, a metal spade 30, a hand end cap 40, a first foot pad 50 and a second foot pad 60. FIG. 2 illustrates how the handle 20 and the metal spade 30 are aligned and attached. The current configuration allows for a slight curvature of the metal spade 30 at the attachment point of the handle 20. In addition, it depicts the second foot pad 60 and demonstrates that the second foot pad 60 is welded to the backside of the handle 20. The first foot pad 50 is associated with the upper edge of the metal spade 30 and is used for the first level of digging. The second foot pad 60 is used once you reach a certain depth. In particular the second foot pad 60 is located approximately fifteen inches above the metal spade 30. The second foot pad 60 measures approximately one and one-half inches thick and approximately six inches in width. The second foot pad 60 offers the user the ability to continue to have foot leverage when digging without being forced to bend over or to get down into the hole which is being dug. By allowing for the additional foot leverage, it prevents added pressure on a user's back.

Both FIG. 1 and FIG. 2 illustrate the hand end cap 40. The hand end cap 40 is used to assists in maneuvering the hand and foot shovel 10 during the digging process, it can assist in the lifting process of digging or it can be used during storage. For example, the hand end cap 40 could be used to hang the hand and foot shovel 10 in one's garage. Typically, the hand end cap 40 is comprised of wood. However, in the current example, the hand end cap 40 would be comprised of a galvanized metal and then covered with a rubber grip type surface. This combination would make the hand end cap 40 a more comfortable configuration for use.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

1. A hand and foot shovel for digging comprising:
a elongated handle comprised of a galvanized metal having a first end and second end;
a metal spade attached to the first end of the handle having a first foot pad;
a hand end cap attached to the second end of the handle wherein said handle end cap is comprised of galvanized metal; and
a second foot pad welded to a backside of the elongated handle, the second foot pad extending outwardly from the handle at a predetermined position on the handle between the first foot pad of the metal spade and the hand end cap such that a user of the shovel uses both the first and second foot pads to dig.

2. A hand and foot shovel of claim 1, wherein said metal spade is operable for digging.

3. A hand and foot shovel of claim 1, wherein said first foot paid and said second foot pad are operable to drive the metal spade into the ground.

4. A hand and foot shovel of claim 1, wherein the
handle is operable for lifting.

5. (canceled)

6. (canceled)

7. A hand and foot shovel of claim 4, wherein the handle measures approximately one and eleven-sixty-fourths as an outside diameter.

8. A hand and foot shovel of claim 1, wherein the handle is approximately forty-four inches long.

9. A hand and foot shovel of claim 1, wherein the metal spade measures approximately thirteen inches in length.

10. A hand and foot shovel of claim 1, wherein said second foot pad measures approximately 6 inches in width and approximately one and one-half inches in thickness.

11. A hand and foot shovel system for digging a hole comprising:
a elongated handle measuring approximately forty four inches in length and comprised of galvanized metal;
a shovel blade attached to a first end of said handle and further comprising a first foot pad;
a second foot pad welded to a backside of the handle approximately fifteen inches up from said shovel blade;
an end cap attached to a second end of said handle comprising a galvanized metal.

12. A hand and foot shovel system of claim 11, wherein said first foot pad and said second foot paid are operable to cause the shovel blade to dig.

13-17. (canceled)
